(19) United States
(12) Patent Application Publication
(10) Pub. No.: US 2015/0363059 A1
(43) Pub. Date: Dec. 17, 2015

(54) MOBILE TERMINAL APPARATUS AND CONTROL METHOD FOR MOBILE TERMINAL APPARATUS

(71) Applicant: KYOCERA Corporation, Kyoto-shi (JP)

(72) Inventors: Hiroshi TSUNODA, Osaka (JP); Rie KANAZAWA, Osaka (JP)

(73) Assignee: KYOCERA Corporation

(21) Appl. No.: 14/834,250

(22) Filed: Aug. 24, 2015

Related U.S. Application Data
(63) Continuation of application No. PCT/JP2014/054545, filed on Feb. 25, 2014.

(30) Foreign Application Priority Data
Feb. 25, 2013 (JP) 2013-034958

(51) Int. Cl. G06F 3/0482; H04M 1/725; H04W 68/00; G06F 3/0484; H04L 12/58

(52) U.S. Cl. CPC G06F 3/0482; G06F 3/04842; H04L 51/38; H04W 68/005; H04M 1/72522; H04W 88/02

(57) ABSTRACT

A mobile phone includes a storage module configured to store a correspondence table which associates notification information and a plurality of applications used for a response to the notification information, and a notification control module configured to display notification information on a display surface, display on the display surface a menu dialog for selecting an application to be launched from among a plurality of applications associated with notification when an operation to designate notification information is received by a touch detection module, and launch the selected application when an operation to select an application is received by the touch detection module. The notification control module is configured to change an arrangement of a plurality of applications in the menu dialog in accordance with a priority.

### CROSS-REFERENCE TO RELATED APPLICATION

The present application is a bypass continuation of international PCT Application No. PCT/JP2014/054545 filed on Feb. 25, 2014, entitled “Mobile Terminal Device and Method for Controlling Mobile Terminal Device”, which claims the benefit of Japanese Application No. 2013-034958, filed on Feb. 25, 2013, entitled “Mobile Terminal Apparatus and Control Method for Mobile Terminal Apparatus”. The disclosure of the above applications are each incorporated herein by reference.

### FIELD

The present disclosure relates to a mobile terminal apparatus and a control method for a mobile terminal apparatus, particularly to a mobile terminal apparatus such as a mobile phone, a PDA (Personal Digital Assistant), a tablet PC, an electronic book terminal, or the like and a control method for the mobile terminal apparatus.

### BACKGROUND

In a conventional mobile phone, when an e-mail arrives, an arrival of a new e-mail is notified to a user through an indication by a display module. In a mobile phone, various notification information including not only an arrival of an e-mail but also a missed call, a passed alarm time, and the like are displayed on a display module.

In such a mobile phone, a configuration can be employed by which, when a user designates notification information, an application corresponding to the designated notification information is launched, so that the user can immediately respond to notification information. When such a configuration is employed, for example, if notification information related to a new e-mail is designated by a user, an e-mail application is launched, and a list of new e-mails or a detailed content of the new e-mail is displayed on a display module.

### SUMMARY

A mobile terminal apparatus according to one embodiment comprises a display module configured to comprise a display surface, an operation receiving module configured to receive an operation by a user, a storage module configured to store correspondence information associating notification information with a plurality of applications for a response to the notification information, and a notification control module configured to display the notification information on the display surface, display on the display surface a selection image for selecting an application to be launched from among a plurality of applications associated with the notification information when an operation to designate the notification information is received by the operation receiving module, and launch the selected application when an operation to select the application is received by the operation receiving module. The notification control module is configured to change an arrangement of a plurality of applications associated with the notification information in the selection image based on priorities.

Another embodiment relates to a control method for a mobile terminal apparatus comprising a display module configured to comprise a display surface, and an operation receiving module configured to receive an operation by a user. This control method comprises the first step of displaying notification information on the display surface, the second step of displaying on the display surface a selection image for selecting an application to be launched from among a plurality of applications associated with the notification information when an operation to designate the notification information is received by the operation receiving module, and the third step of launching the selected application when an operation to select the application is received by the operation receiving module. In the second step, an arrangement of a plurality of applications associated with the notification information in the selection image is changed based on priorities.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 represents a configuration of a mobile phone in accordance with the embodiment.

FIG. 2 is a block diagram representing an entire configuration of a mobile phone in accordance with the embodiment.

FIG. 3 represents a correspondence table in accordance with the embodiment.

FIG. 4 is a diagram for illustrating a screen displayed on a display surface when an application is executed in accordance with the embodiment.

FIG. 5 is a flowchart representing a first notification control processing in accordance with the embodiment.

FIG. 6 is a flowchart representing a second notification control processing in accordance with the embodiment.

FIG. 7 is a flowchart representing a menu dialog display processing included in the second notification control processing in accordance with the embodiment.

FIG. 8 represents one example of a screen transition which is provided when the second notification control processing is executed in accordance with the embodiment.

FIG. 9 represents one example of a screen transition which is provided when the second notification control processing is executed in accordance with the embodiment.

FIG. 10 represents one example of a screen transition which is provided when the second notification control processing is executed in accordance with the embodiment.

FIG. 11 represents one example of a screen transition which is provided when the second notification control processing is executed in accordance with the embodiment.

FIG. 12 represents one example of a screen transition which is provided when the second notification control processing is executed in accordance with the embodiment.

FIG. 13 is a flowchart representing a menu dialog display processing in accordance with a modified example 1.

FIG. 14 represents an example in which priorities of applications and an arrangement of menus in a menu dialog are changed in accordance with a time at which an operation for a response to missed call information is performed in accordance with a modified example 1.

FIG. 15 represents an example in which priorities of applications and an arrangement of menus in a menu dialog are changed in accordance with use frequencies of an e-mail, an SMS, and a voice mail before an operation for a response to new message information is performed in accordance with a modified example 1.

FIG. 16 is a flowchart representing a notification lock control processing in accordance with a modified example 2.

FIG. 17 represents a list screen in which a lock setting is applied to notification information in accordance with a modified example 2.

FIG. 18 is a flowchart representing the second notification control processing in accordance with a modified example 2.

FIG. 19 is a flowchart representing a copy control processing in accordance with a modified example 3.

FIG. 20 is a flowchart representing a copy information display control processing in accordance with a modified example 3.

FIG. 21 represents one example of a screen transition which is provided when the copy information display control processing is executed in accordance with a modified example 3.

### DETAILED DESCRIPTION

When a user confirms notification information, the user in some cases would like to respond in a different manner with respect to the same kind of notification in accordance with a situation at that time. For example, when a user confirms notification information related to a missed call, it is generally conceivable that the user makes a telephone call to a caller if a time at which the user confirmed the notification information is within a daytime. However, if a time at which the user confirmed the notification information is within a midnight, it is generally conceivable that the user sends an e-mail to the caller. According to the mobile terminal apparatus and the control method for the mobile terminal apparatus of the present disclosure, a user can perform various responses with respect to notification information.

In the following paragraphs, the embodiment will be described with reference to the drawings.

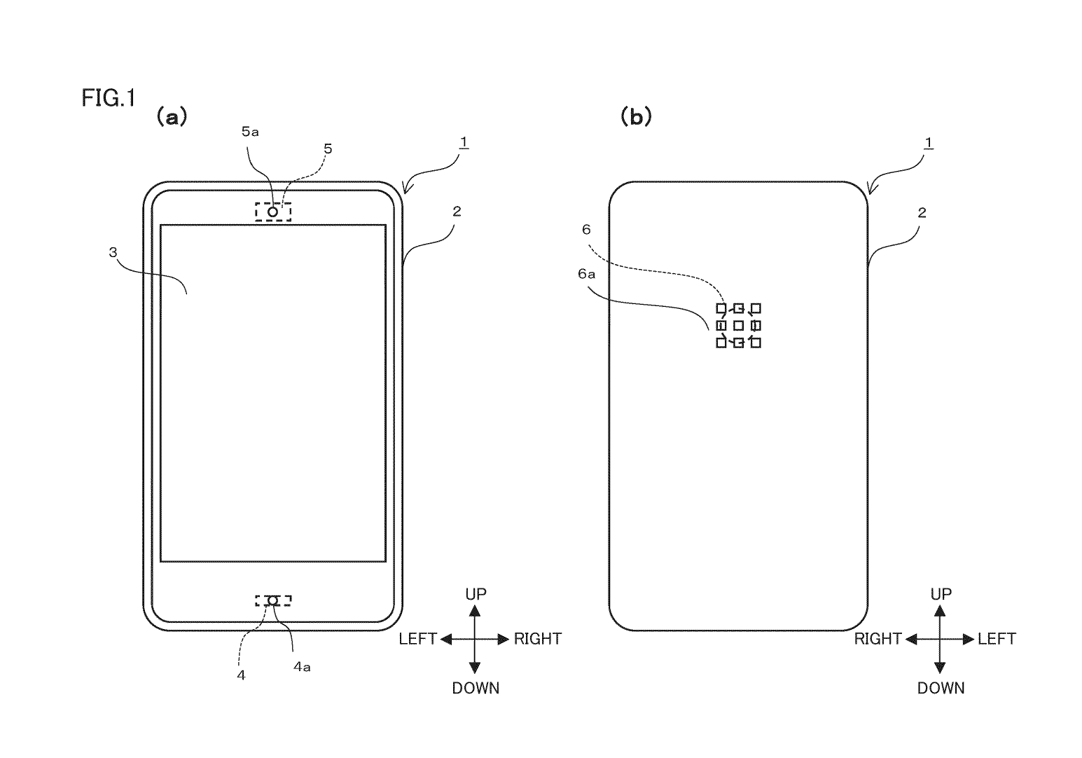

FIG. 1 represents a configuration of a mobile phone 1. FIGS. 1(a) and 1(b) are a front view and a rear view of mobile phone 1, respectively.

In the following paragraphs, for ease of description, a longitudinal direction of a cabinet 2 will be defined as an upward/downward direction, and a short direction of cabinet 2 will be defined as a leftward/rightward direction, as shown in FIG. 1.

Mobile phone 1 includes a cabinet 2, a display surface 3, a microphone 4, a telephone call speaker 5, and an external speaker 6.

Cabinet 2 has a substantially rectangular contour when viewed from a front face. On a front face of cabinet 2, display surface 3 of a display module 13 described later can be arranged. Various images (screens) can be displayed on display surface 3.

In cabinet 2, microphone 4 can be arranged in a lower end portion, and telephone call speaker 5 can be arranged in an upper end portion. A voice can be inputted to microphone 4 through a microphone hole 4a formed on a front face of cabinet 2. Microphone 4 can generate an electric signal in accordance with an inputted sound. A voice can be outputted from telephone call speaker 5. The outputted voice can be emitted to outside through an output hole 5a formed on a front face of cabinet 2. When a telephone call is made, a received voice which is received from equipment (a mobile phone or the like) of a communication destination can be outputted from telephone call speaker 5, and an uttered voice which is uttered by a user can be inputted to microphone 4.

In cabinet 2, external speaker 6 can be arranged. On a back face of cabinet 2, output holes 6a corresponding to external speaker 6 can be formed. A sound (a voice, an informing sound, and the like) outputted from external speaker 6 can be emitted through output holes 6a.

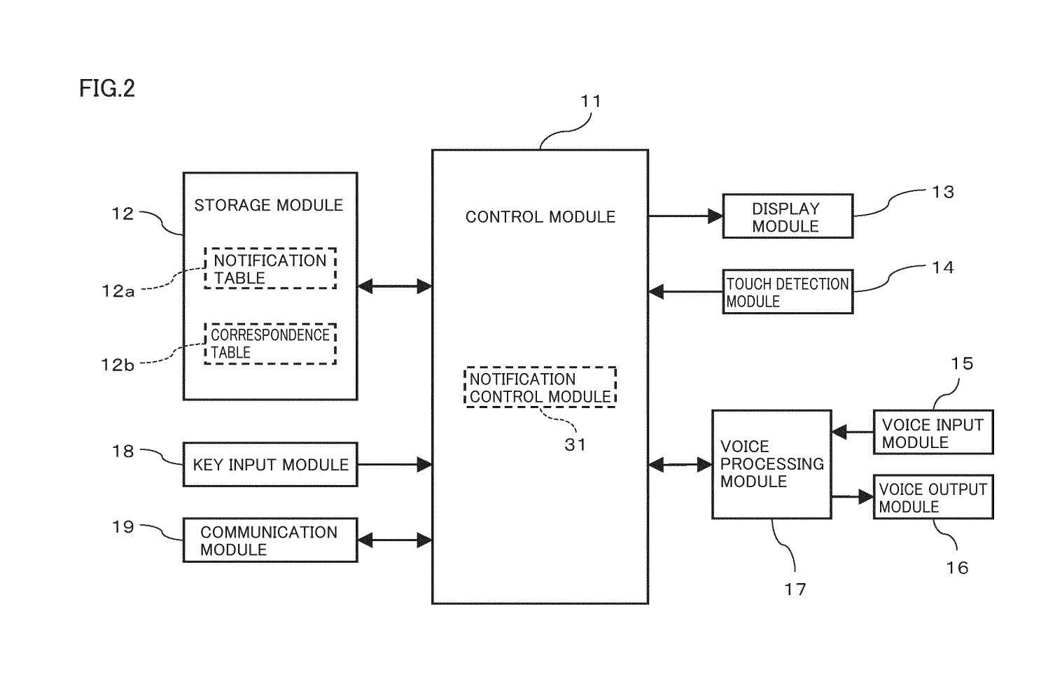

FIG. 2 is a block diagram representing an entire configuration of mobile phone 1. Mobile phone 1 includes a control module 11, a storage module 12, a display module 13, a touch detection module 14, a voice input module 15, a voice output module 16, a voice processing module 17, a key input module 18, and a communication module 19.

Storage module 12 can be constituted of an ROM, an RAM, an external memory, and the like. Various programs can be stored in storage module 12. The programs stored in storage module 12 include various programs for controlling each module of mobile phone 1 and various applications (for example, telephone, e-mail, map, game, schedule management, and the like). The programs are stored in storage module 12 by a manufacturer at the time of manufacturing mobile phone 1 or can be stored in storage module 12 by a user through a communication network or a storage medium such as a memory card.

Storage module 12 can also include a working area for storing data which is temporarily used or generated at the time of execution of the program.

Storage module 12 can store a notification table 12a and a correspondence table 12b. Notification table 12a can store various notification information. Notification information can include missed call information related to a missed call and new message information related to a new arrival of a message. Missed call information is, for example, a telephone number of a caller. New message information is a mail address of a sender when the message is an e-mail, and it is a telephone number of a sender when the message is an SMS (Short Message Service) or a voice mail. Further, the notification information includes information indicating that an alarm time has passed, information that a scheduled time of a schedule has passed, information related to an update of mobile phone 1, and information that an external memory is connected to mobile phone 1.

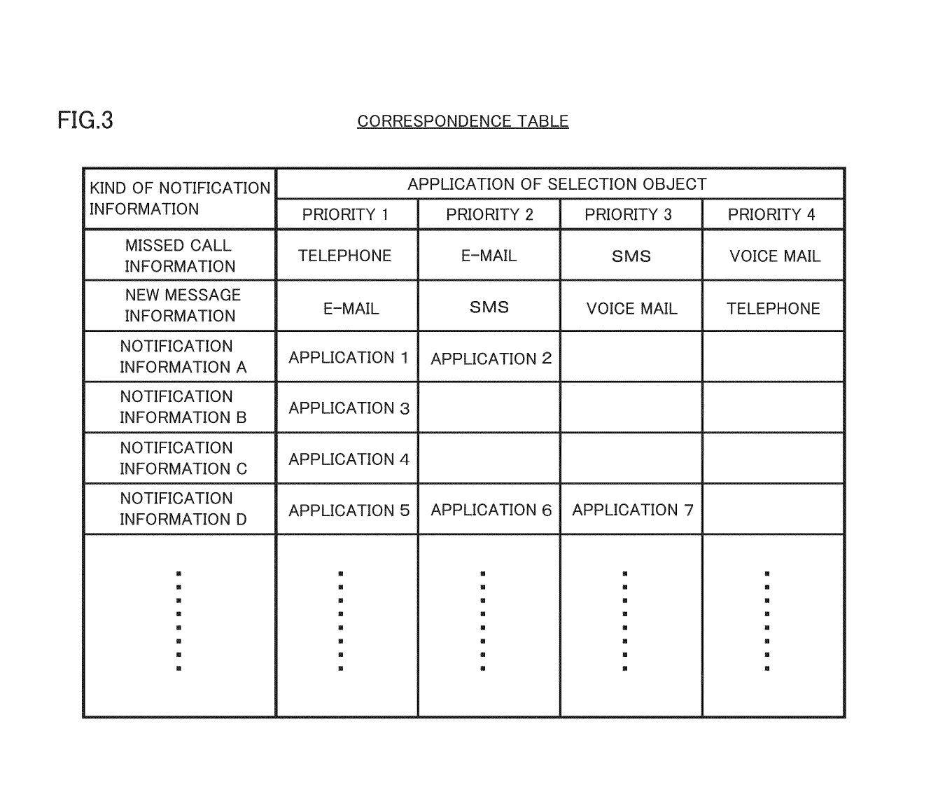

FIG. 3 represents correspondence table 12b. In correspondence table 12b, notification information and applications for a response to the notification information can be associated. In correspondence table 12b, one or more application can be associated in accordance with a kind of notification information. When a plurality of applications are associated, a priority is given to each application. The priority can be set so that an application which is likely to be executed by a user with respect to notification information is in a higher rank.

For example, as shown in FIG. 3, missed call information can be associated with a telephone application, an e-mail application, an SMS application, and a voice mail application. When a missed call is present, a user is likely to make a phone call to a caller. Therefore, priorities can be given to each application in the order of “TELEPHONE,” “E-MAIL,” “SMS,” and “VOICE MAIL.”

The new message information can be associated with the e-mail application, the SMS application, the voice mail application, and the telephone application. When an arrival of a new message (e-mail, SMS, voice mail) is present, a user is likely to send a message to a sender. Therefore, priorities can be given to each application in the order of “E-MAIL,” “SMS,” “VOICE MAIL,” and “TELEPHONE.”

It should be noted that one application among the e-mail application, the SMS application, and the voice mail application can correspond to a first message application of the present disclosure, and one application among the remaining two applications can correspond to a second message application of the present disclosure.

Control module 11 is constituted of a CPU and the like. Control module 11 can control each module (storage module 12, display module 13, touch detection module 14, voice input module 15, voice output module 15, voice processing module 17, key input module 18, communication module 19, and the like) constituting mobile phone 1 in accordance with a program.

Display module 13 can be constituted of a liquid crystal display or the like. Display module 13 can display an image (screen) on display surface 3 based on a control signal and an image signal from control module 11. Display module 13 is not limited to a liquid crystal display, and it may be constituted of other display apparatus such as an organic electroluminescence display or the like.

Touch detection module 14 can be constituted of a touch panel or the like configured to detect a contact of a finger to display surface 3. The touch panel can be formed into a transparent sheet and arranged on a front face of cabinet 2 so as to overlap with display surface 3. The touch panel may be a touch panel of various types such as an electrostatic capacitance type, an ultrasonic type, a pressure-sensitive type, a resistive film type, an optical detection type, or the like.

Touch detection module 14 can receive a touch operation performed by a user with respect to display surface 3. In other words, touch detection module 14 can detect a position on display surface 3 at which a finger is in contact, namely a touch position, and output a position signal corresponding to the detected touch position to control module 11.

A user can perform various touch operations by touching display surface 3 with a finger. Kinds of touch operations include a tap operation, a flick operation, a slide operation, and the like. The tap operation is an operation in which a user touches display surface 3 with a finger and releases the finger from display surface 3 within a short period of time. The flick operation is an operation in which a user flicks display surface 3 with a finger in any direction. The slide operation is an operation in which a user holds a finger being touched to display surface 3 and moves it in any direction. An operation of performing the tap operation once is a single-tap operation, and an operation of repeating the single tap operation twice within a short period of time is a double-tap operation.

The touch operations will be described more specifically. For example, after the touch position with respect to display surface 3 is detected by touch detection module 14, when the touch position is not detected within a predetermined first time period, it can be determined by control module 11 that the tap operation (single-tap operation) was performed. After the touch position with respect to display surface 3 is detected by touch detection module 14, and the touch position is moved by a distance longer than a predetermined first distance within a predetermined second time period, when touch position is not detected, it can be determined by control module 11 that the flick operation was performed. After the touch position with respect to display surface 3 is detected by touch detection module 14, when the touch position is moved by a distance longer than or equal to a predetermined second distance, it can be determined by control module 11 that the slide operation was performed. After a first tap operation, when one or more touch operation is detected within a predetermined third time period, it can be determined by control module 11 that the double-tap operation was performed.

Voice input module 15 can be constituted of microphone 4 and the like. Voice input module 15 can output an electric signal from microphone 4 to voice processing module 17.

Voice output module 16 can include telephone call speaker 5 and external speaker 6. An electric signal from processing module 17 can be inputted to voice output module 16, and a sound (a voice, an informing sound, and the like) can be outputted from telephone call speaker 5 or external speaker 6.

Voice processing module 17 can apply an A/D conversion and the like to the electric signal from voice input module 15 and output the converted digital voice signal to control module 11. Voice processing module 17 can apply a decoding processing, a D/A conversion, and the like to the digital voice signal from control module 11 and output the converted electric signal to voice output module 16.

When various hard keys (not shown), such as a power key for turning on a power of mobile phone 1, arranged on mobile phone 1 are pressed, key input module 18 can output a signal in accordance with the pressed hard key to control module 11.

Communication module 19 can include a circuit for converting a signal, an antenna for communicating a radio wave, and the like to perform a telephone call or a communication. Communication module 19 can convert a signal inputted from control module 11 for a telephone call or a communication into a radio signal, and transmit the converted radio signal to a communication destination such as a base station, other communication device, or the like through the antenna. Further, communication module 19 can convert the radio signal received through the antenna into a signal of a type which can be used by control module 11, and output the converted signal to control module 11.

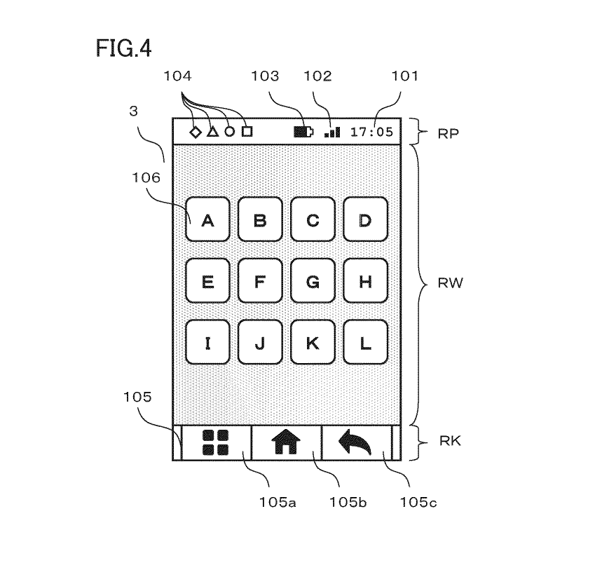

FIG. 4 is a diagram for illustrating a screen displayed on display surface 3 when an application is executed. Control module 11, as described above, can execute various applications and display a screen including an execution screen of an application on display surface 3.

As shown in FIG. 4, the screen displayed on display surface 3 is constituted of a pictogram region RP, a window region RW, and a key region RK. A current time 101, a residual quantity meter 102 indicating a battery residual quantity, and an intensity meter 103 indicating an intensity of a radio wave can be displayed in pictogram region RP. Further, notification icons 104 corresponding to various notification information such as the missed call information and new message information described above can be displayed in pictogram region RP. A user can confirm a kind of notification information by confirming notification icon 104. Further, when a predetermined operation is performed by a user, a list screen of notification information described later can be displayed on display surface 3.

An operation key group 105 can be displayed in key region RK. Operation key group 105 can be constituted of a setting key 105a, a home key 105b, and a back key 105c. Setting key 105a is a key for mainly displaying on display surface 3 a setting screen for performing various settings. Home key 105b is a key for mainly allowing a display of display surface 3 to shift from other screen to a home screen. Back key 105c is a key for mainly returning an executed processing to a previous processing by one step.

An execution screen of an application can be displayed on window region RW. For example, as shown in FIG. 4, when a home application is executed, a home screen is displayed on window region RW. Launching icons 106 corresponding to various applications such as a telephone and an e-mail can be arranged on the home screen.

It should be noted that, depending on an application to be executed, there is a case where at least one of pictogram region RP and key region RK is not displayed, and window region RW is extended to the region where pictogram region RP or key region RK is not displayed.

Mobile phone 1 of the embodiment includes a notification function application which can display notification information on display surface 3. Control module 11 can execute a control processing related to the notification function application (hereinafter, referred to as “notification control processing”). Control module 11 includes a notification control module 31 to execute the notification control processing. Notification control module 31 can be achieved as a function of a program executed by control module 11.

In the notification control processing, notification control module 31 can display notification information on display surface 3, and display a menu dialog 108 for selecting an application to be launched from among a plurality of applications associated with notification information when an operation of designating notification information is received by touch detection module 14. In menu dialog 108, notification control module 31 can change an arrangement of a plurality of applications associated with notification information for each notification information by following priorities set for each notification information.

Further, notification control module 31 can launch a selected application when an operation of selecting an application from menu dialog 108 is received by touch detection module 14.

The notification control processing can include a first notification control processing and a second notification control processing. Notification control module 31 can execute the first notification control processing and the second notification control processing.

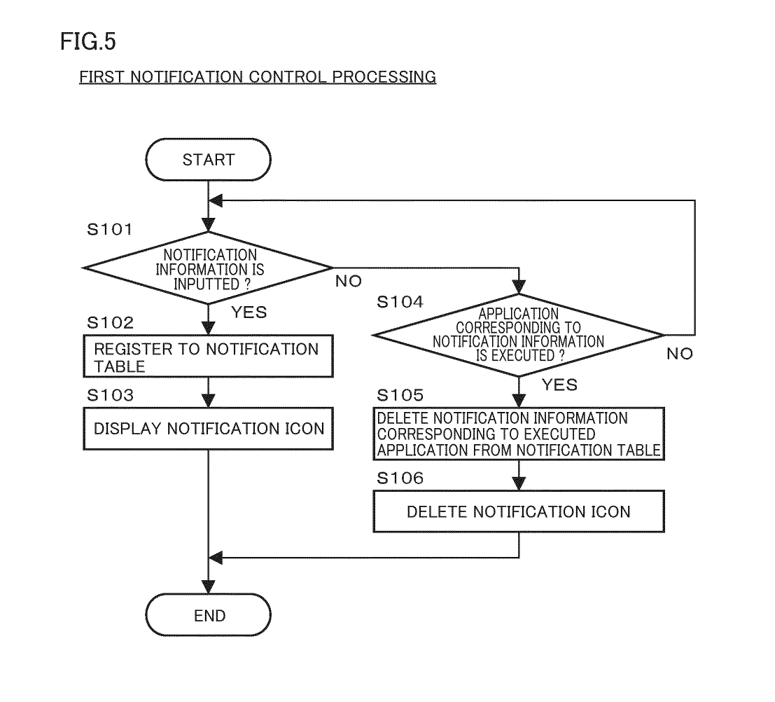

FIG. 5 is a flowchart representing the first notification control processing. In the following paragraphs, the first notification control processing will be described with reference to FIG. 5.

When notification information such as an arrival of an e-mail is generated, notification information can be inputted from an application handling the notification information to notification control module 31. When notification control module 31 obtains the notification information (S101:YES), it can register the obtained notification information to notification table 12a (S102).

Next, as shown in FIG. 4, notification control module 31 can display notification icon 104 corresponding to the registered notification information on pictogram region RP (S103).

When no notification information is inputted, notification control module 31 can determine, in the second notification control processing described later, whether or not an application for a response to the notification information was executed (S104). When notification control module 31 determines that the application was executed (S104:YES), it can delete the notification information corresponding to the executed application from notification table 12a (S105). Further, notification control module 31 can delete notification icon 104 corresponding to the deleted notification information from pictogram region RP (S106).

The first notification control processing can be executed repeatedly by notification control module 31 while mobile phone 1 is under operation.

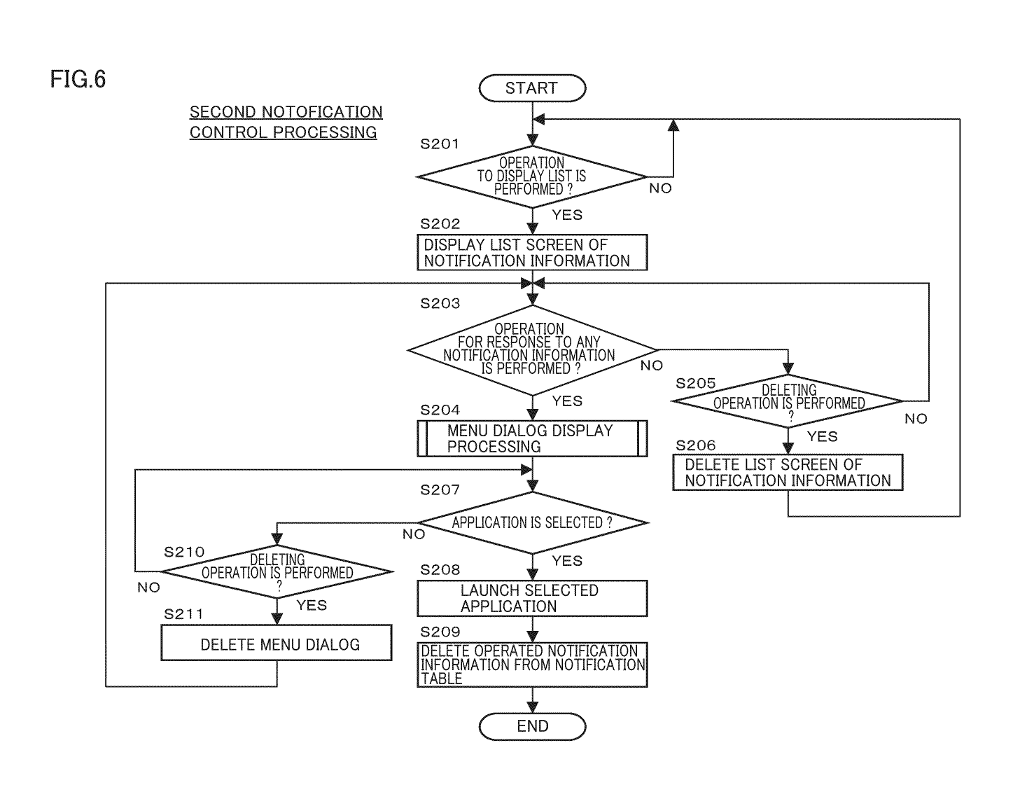

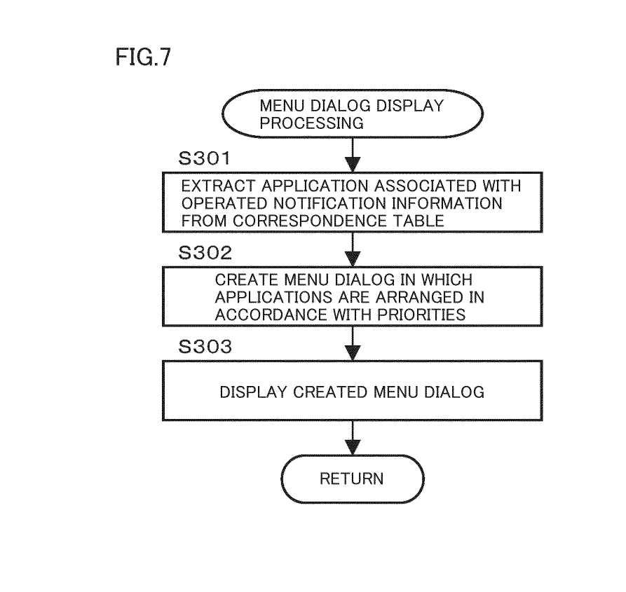

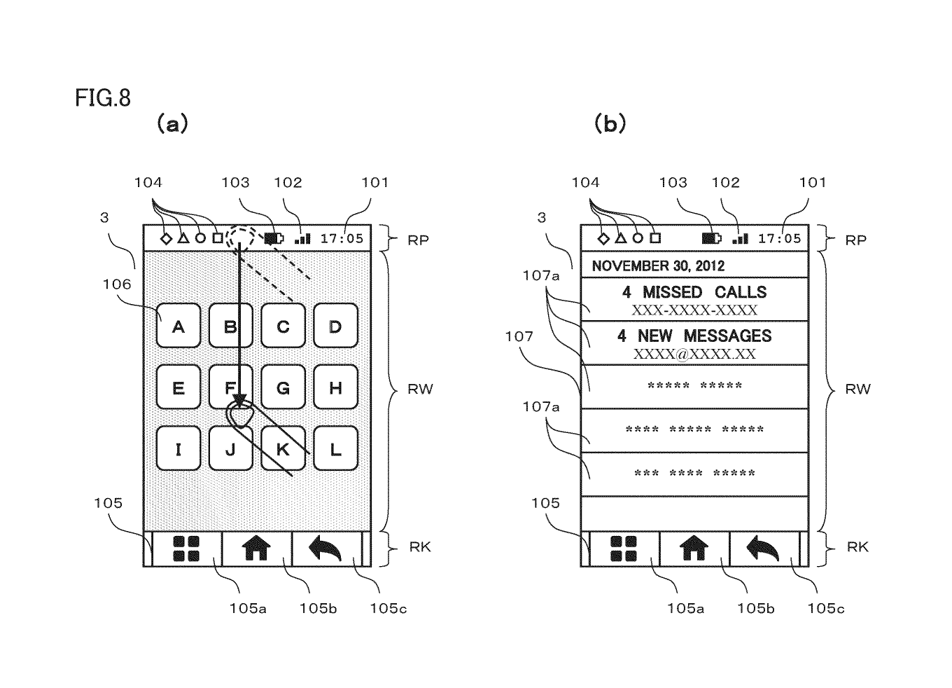

FIG. 6 is a flowchart representing the second notification control processing. FIG. 7 is a flowchart representing a menu dialog display processing included in the second notification control processing. FIGS. 8 to 12 represent one example of a screen transition which is provided when the second notification control processing is executed.

When a screen including pictogram region RP is displayed on display surface 3 by launching an application, the second notification control processing can be started. The second notification control processing can be executed in parallel with the first notification control processing. In the following paragraphs, the second notification control processing will be described with reference to FIGS. 6 to 12.

Notification control module 31 can determine whether or not an operation for displaying a list of notification information on display surface 3 (S201). The operation for displaying a list is, for example, an operation in which a user moves a finger touching pictogram region RP downward by a distance longer than a predetermined distance, as shown in FIG. 8(a).

When notification control module 31 determines that the operation for displaying a list was performed (S201:YES), it can read notification information from notification table 12a and display a list screen 107 of read notification information on display surface 3 (window region RW) (S202). As shown in FIG. 8(b), notification information can be displayed on each display column 107a constituting a display list screen 107. In the embodiment, when the notification information is missed call information, a plurality of missed call information are collectively displayed in one display column 107a. For example, the number of missed calls and the latest missed call information (such as telephone numbers) can be displayed on display column 107a. Similarly, when the notification information is new message information, a plurality of new message information can be collectively displayed on one display column 107a. For example, the number of new messages and the latest new message information (such as mail addresses) can be displayed on display column 107a. In FIG. 8(b), an example is shown in which there are four items for each of missed call information and new message information.

Notification control module 31 can determine whether or not an operation for a response to notification information is performed with respect to any of display columns 107a of notification information (S203). The operation for a response is, for example, the single-tap operation.

When notification control module 31 determines that an operation for a response was performed (S203:YES), it can execute the menu dialog display processing shown in FIG. 7 (S204).

Notification control module 31 can firstly extract an application associated with the operated notification information from correspondence table 12b (S301). Next, notification control module 31 can generate a menu dialog 108 in which menus 108a indicating applications are arranged in accordance with priorities set in correspondence table 12b (S302), and display generated menu dialog 108 on display surface 3 (S303). In menu dialog 108, menus 108a indicating applications can be arranged from an upper side to a lower side in the order of applications having a higher priority.

When menus 108a are arranged in an upward/downward direction on display surface 3, a user generally confirms menus 108a from an upper side in order. The priorities are set such that an application which is likely to be executed by a user for a response to the notification information is in a higher rank. Menu 108a of an application which is more likely to be executed by a user can be arranged on an upper side of menu dialog 108.

It should be noted that, when there is only one application associated with notification information, notification control module 31 can display menu dialog 108 constituted of menu 108a indicating one application on display surface 3.

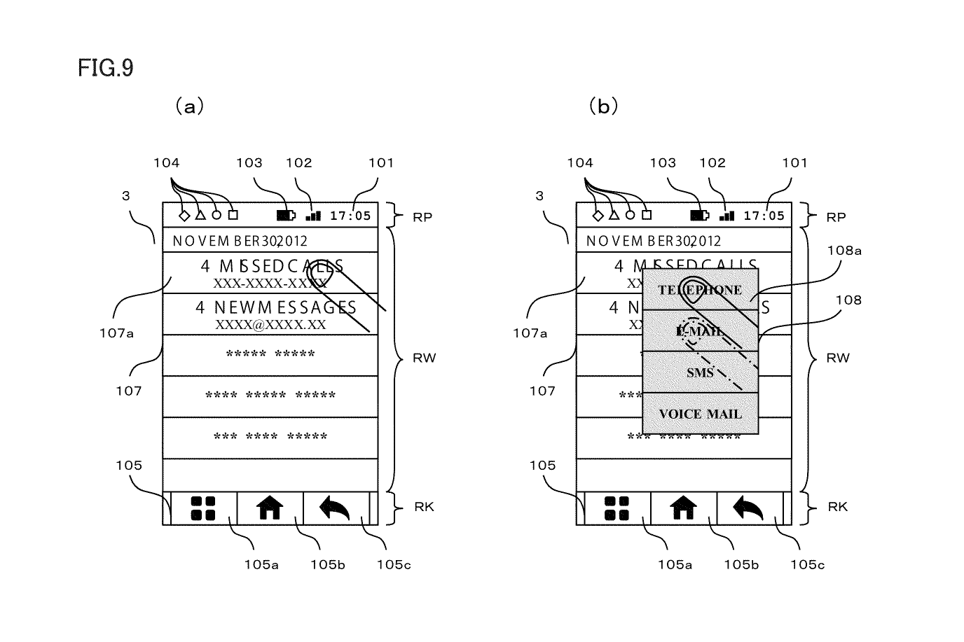

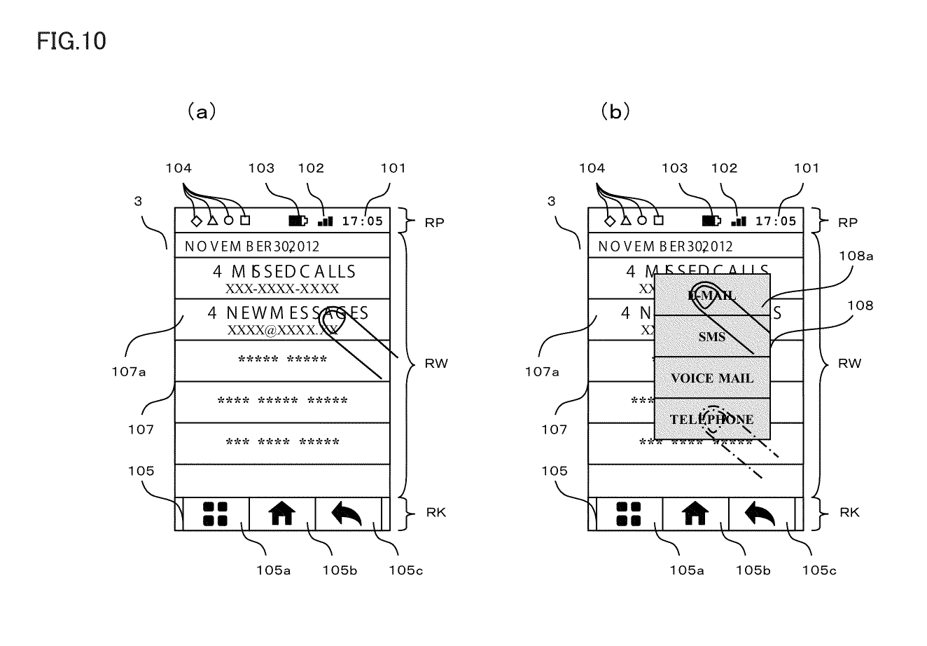

For example, when a user performed an operation for a response to display column 107a of missed call information as shown in FIG. 9(a), notification control module 31 can display menu dialog 108 corresponding to the missed call information on display surface 3 so as to overlap with list screen 107 as shown in FIG. 9(b). In menu dialog 108 corresponding to missed call information, menus 108a indicating applications can be arranged in the order of “TELEPHONE,” “E-MAIL,” “SMS,” and “VOICE MAIL.” When a user performed an operation for a response to display column 107a of new message information as shown in FIG. 10(a), notification control module 31 can display menu dialog 108 corresponding to new message information on display surface 3 so as to overlap with list screen 107 as shown in FIG. 10(b). In menu dialog 108 corresponding to new message information, menus 108a indicating applications can be arranged in the order of “E-MAIL,” “SMS,” “VOICE MAIL,” “TELEPHONE.”

Returning to FIG. 6, when notification control module 31 determines that a cancelling operation, for example, a single-tap operation to back key 105c was performed without performing an operation for a response (S205:YES), it can delete list screen 107 (S206). On display surface 3, a screen prior to displayed list screen 107 can be displayed.

When menu dialog 108 is displayed by the processing of Step S204, notification control module 31 then can determine whether or not any application is selected from menu dialog 108 by an operation of selecting any menu 108a, for example, a single-tap operation to menu 108a (S207). When notification control module 31 determines that an application was selected (S207:YES), it can launch the selected application (S208).

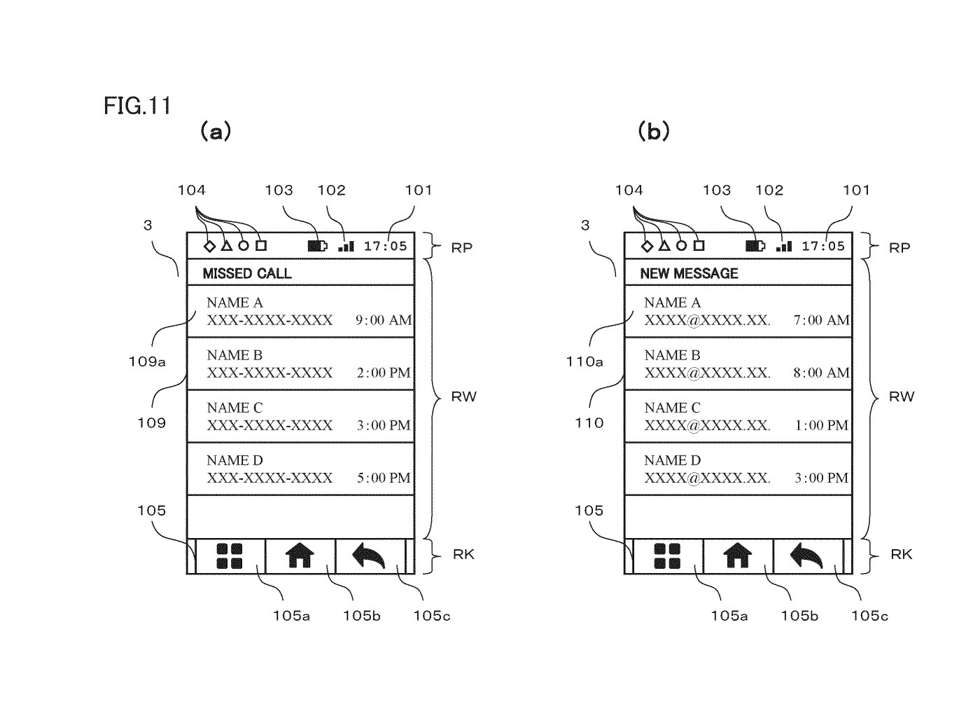

For example, as shown in FIG. 9(b), when menu dialog 108 corresponding to missed call information is displayed on display surface 3, and menu 108a of “TELEPHONE” is selected from this menu dialog 108, notification control module 31 can launch a telephone application. When the telephone application is launched, notification control module 31 can supply all missed call information (phone number, caller's name, called time, and the like) to the telephone application. As shown in FIG. 11(a), when the telephone application is launched, list screen 109 having missed call information displayed on each display column 109a is displayed on display surface 3. When desired missed call information is selected by a user from list screen 109, control module 11 makes a phone call to a caller terminal corresponding to the selected missed call information.

As shown in FIG. 10(b), when menu dialog 108 corresponding to new message information is displayed on display surface 3, and menu 108a of “E-MAIL” is selected from this menu dialog 108, notification control module 31 launches an e-mail application. When the e-mail application is launched, notification control module 31 supplies new message information (mail address, sender's name, sent time, and the like) to the e-mail application. As shown in FIG. 11(b), when the e-mail application is launched, list screen 110 having new message information displayed on each display column 110a can be displayed on display surface 3. When desired new message information is selected by a user from list screen 110, control module 11 can allow a screen for creating an e-mail directed to a sender corresponding to new message information to be displayed. On the other hand, when menu 108a of “E-MAIL” is selected from menu dialog 108 corresponding to missed call information shown in FIG. 9(b), notification control module 31 can launch the e-mail application. Storage module 12 stores a telephone directory table (not shown) in which contact information such as phone numbers and mail addresses are registered. When the e-mail application is launched, if callers of all missed call information are registered in the telephone directory table, notification control module 31 can read mail addresses, names, and the like of senders from the telephone directory table and supply the same to the e-mail application. When the e-mail application is launched, list screen 110 similar to the example of FIG. 11(b) having mail addresses, names, and the like displayed on each display column 110a is displayed on display surface 3.

When menu 108a of “TELEPHONE” is selected from menu dialog 108 corresponding to new message information shown in FIG. 10(b), notification control module 31 can launch the telephone application. When the telephone application is launched, if callers of all new message information are registered in the telephone directory table, notification control module 31 can read telephone numbers, names, and the like of callers from the telephone directory table and supply the same to the telephone application. When the telephone application is launched, list screen 109 similar to the example of FIG. 11(a) having telephone numbers, names, and the like displayed on each display column 109a can be displayed on display surface 3.

When notification control module 31 launches the application in Step S208, it can delete the operated notification information from notification table 12a (S209). Accordingly, the second notification control processing is terminated.

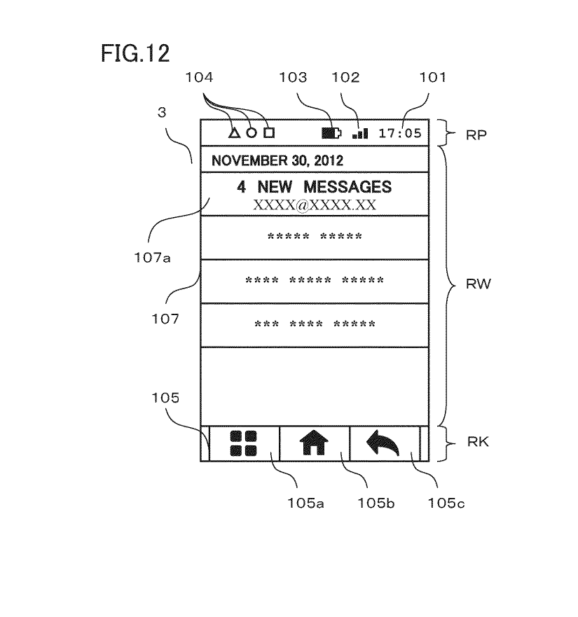

As shown in FIG. 12, for example, when missed call information is deleted from notification table 12a, if a user performs a list displaying operation again, and list screen 107 is displayed, missed call information is not displayed on list screen 107.

As described above, according to the embodiment, notification information displayed on list screen 107 is associated with a plurality of applications for a response to the notification information, and menu dialog 108 for selecting an application to be launched is displayed on display surface 3 when notification information is designated. Since a user can launch a suitable application in accordance with a situation at the time when he confirmed the notification information, a convenience for a user can be improved.

Further, according to the embodiment, priorities are set for applications, and menu 108a indicating an application having a higher priority can be arranged on an upper side of menu dialog 108. For each notification information, a priority is set such that an application which is likely to be executed by a user is in a higher rank, so that a user can readily select an application which is likely to be executed from menu dialog 108.

### Modified Example

In the embodiment described above, menus 108a indicating applications having higher priorities are arranged in order from an upper side to a lower side in application menu dialog 108, but the priorities of the applications are not changed.

In the present modified example, when a change condition for changing a priority of an application associated with notification information is set for notification information, a priority is changed in accordance with the change condition.

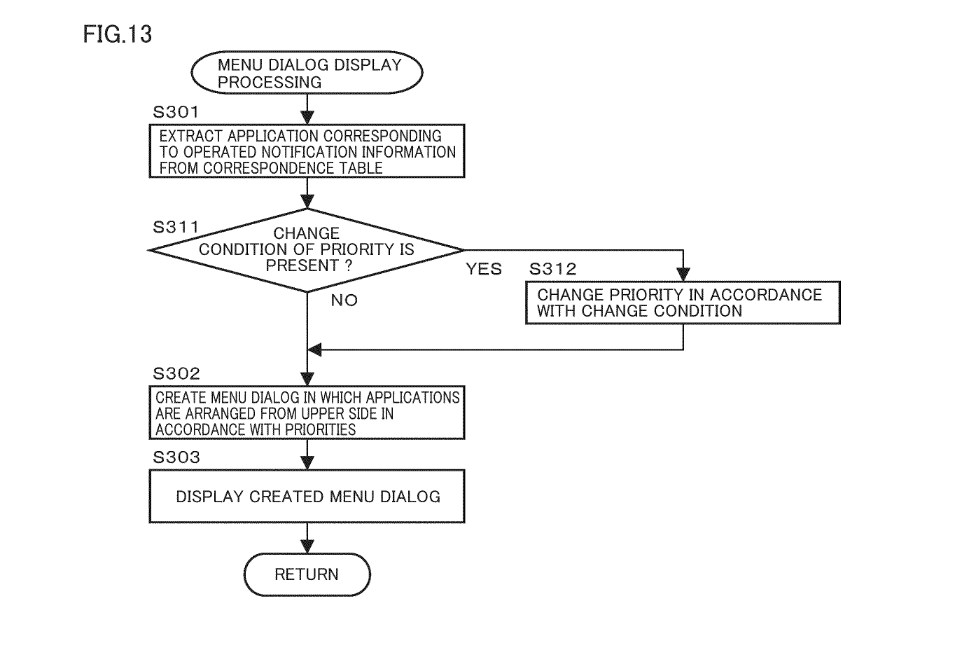

FIG. 13 is a flowchart representing a menu dialog display processing in accordance with the modified example.

In the present modified example, the processing of Steps S311 and S312 are added to the menu dialog display processing shown in FIG. 7.

When notification control module 31 extracts an application associated with operated notification information from correspondence table 12b (S301), it can determine whether or not a change condition is set for the operated notification information (S311). When a change condition is set (S311:YES), notification control module 31 can change a priority of each extracted application in accordance with the change condition (S312).

In the embodiment, change conditions are set for missed call information and new message information. The change condition set for the missed call information is whether or not, when missed call information was designated (an operation for a response was performed) in list screen 107, the time of designation is included within a predetermined time. The predetermined time is a time which is considered to bother a person at the other end if a telephone call is made (for example, the time from 10:00 PM to 7:00 AM).

The change condition set for the new message information is use frequencies of an e-mail, an SMS, and a voice mail in mobile phone 1 before new message information is designated in list screen 107.

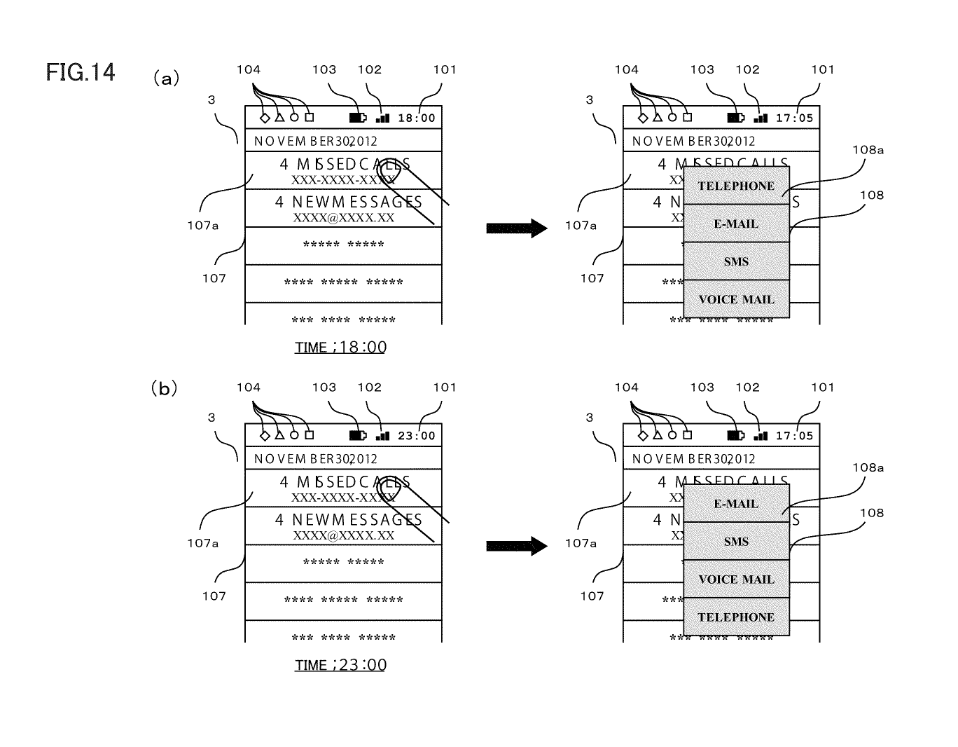

FIG. 14 represents an example in which priorities of applications and an arrangement of menus 108a in menu dialog 108 are changed in accordance with a time on which an operation for a response to missed call information was performed.

When the notification information operated for a response is missed call information, notification control module 31 can determine whether or not a time on which the operation for a response is performed is within the predetermined time in Step S312. If it is not within the predetermined time, it is conceivable that a user is likely to make a telephone call to respond to the missed call. On the other hand, if it is within the predetermined time, it is conceivable that a user is likely to send a message since making a phone call may bother a person at the other end.

When notification control module 31 determines that the time on which the operation for a response was performed is not within the predetermined time, it can create menu dialog 108 so that menus 108a are arranged in the order of “TELEPHONE,” “E-MAIL,” “SMS”, and “VOICE MAIL” from an upper side in accordance with priorities in correspondence table 12b, and display the same on display surface 3, as shown in FIG. 14(a). On the other hand, when notification control module 31 determines that the time on which the operation for a response was performed is within the predetermined time, it can change the order of the message (e-mail, SMS, voice mail) application and the telephone application, create menu dialog 108 so that menus 108a are arranged in the order of “E-MAIL,” “SMS,” “VOICE MAIL,” and “TELEPHONE” from an upper side, and display the same on display surface 3, as shown in FIG. 14(b).

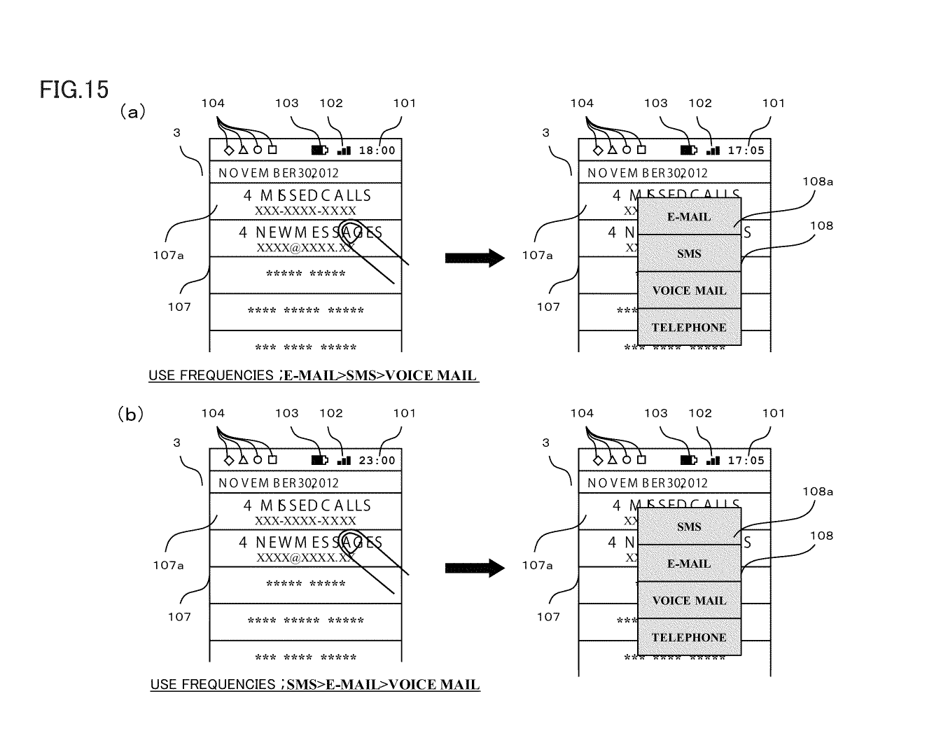

FIG. 15 represents an example in which priorities of applications are changed in accordance with use frequencies of e-mail, SMS, and voice mail before an operation for a response is performed with respect to new message information, and an arrangement of menus 108a of menu dialog 108 is changed.

When the notification information operated for a response is new message information, notification control module 31 can determine use frequencies of each message of e-mail, SMS, and voice mail before the operation for a response is performed in Step S312. For example, notification control module 31 can inspect a history of each message stored in storage module 12 and determine that a use frequency is higher as the number of transmission within a certain time period is greater. It is conceivable that a message having a higher use frequency is more likely to be executed by a user for a response to a new message.

When the order of high use frequencies is the same as the priorities in correspondence table 12b, notification control module 31 can create menu dialog 108 such that menus 108a are arranged in the order of “E-MAIL,” “SMS,” “VOICE MAIL,” and “TELEPHONE” from the upper side in accordance with the priorities in correspondence table 12b, and display the same on display surface 3, as shown in FIG. 15(a). On the other hand, when the order of high use frequencies is the same as the priorities in correspondence table 12b, notification control module 31 can change the priorities of each application of “E-MAIL,” “SMS,” and “VOICE MAIL” to be in a higher rank as the use frequency is higher. For example, when the order of high use frequencies is “SMS,” “E-MAIL,” and “VOICE MAIL,” notification control module 31 can create menu dialog 108 such that menus 108a of “SMS,” “E-MAIL,” “VOICE MAIL,” and “TELEPHONE” are arranged in this order from the upper side, and display the same on display surface 3, as shown in FIG. 15(b).

It should be noted that the priorities of each application of “E-MAIL,” “SMS,” and “VOICE MAIL” associated with missed call information may be changed so as to be in a higher rank as the use frequency is higher.

As described above, according to the present modified example, the priorities of applications can be changed such that applications which are considered likely to be selected by a user are arranged on an upper side in menu dialog 108 in accordance with a situation at the time when a user confirmed the notification information. A user can more readily select an application to be launched from menu dialog 108.

### Modified Example 2

In the embodiment described above, when an application associated with notification information is executed, the notification information for the executed application is deleted from list screen 107 as shown in FIG. 12. For example, when the telephone application is executed to respond to the missed call information, the missed call information can be deleted. When a user defers making a phone call to a person at the other end, or when a person at the other end did not respond to a phone call, a user cannot confirm the missed call information again or cannot launch an application with use of the missed call information.

In mobile phone 1 in accordance with modified example 2, a notification lock function for locking notification information so that notification information displayed on list screen 107 is not deleted from list screen 107 is added to the notification function. Notification control module 31 can execute a notification lock control processing for achieving the notification lock function.

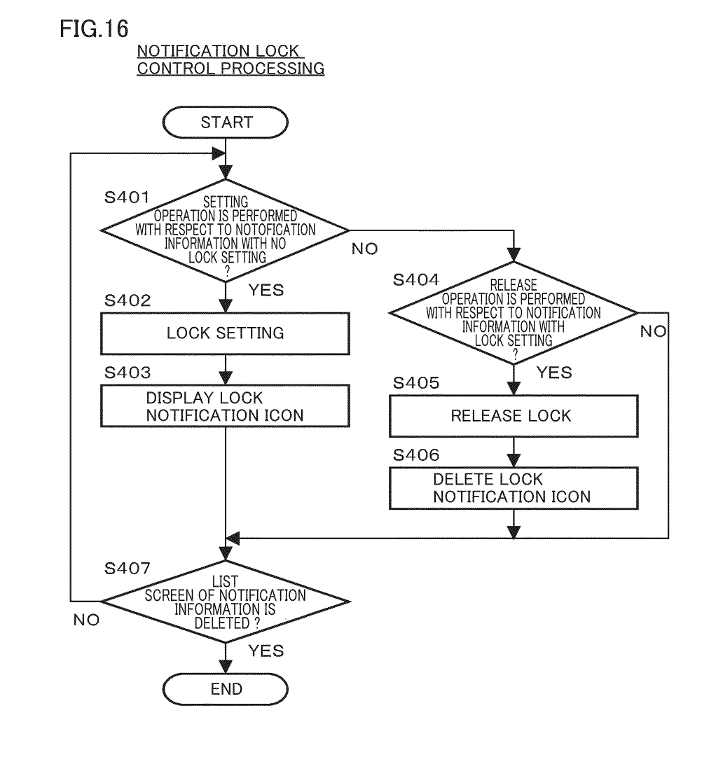

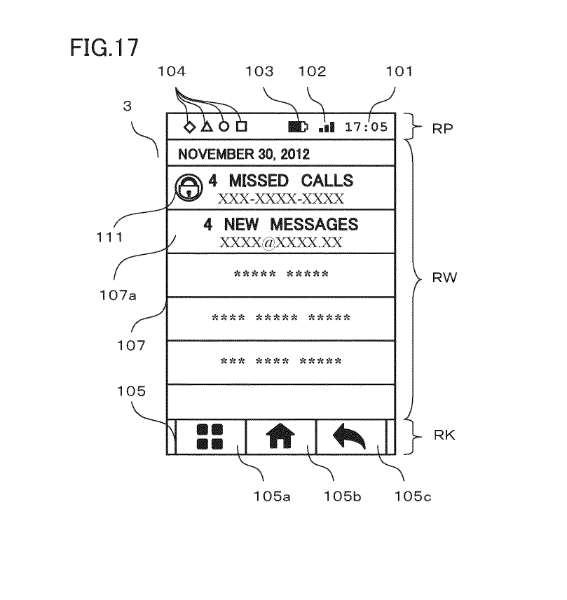

FIG. 16 is a flowchart representing a notification lock control processing in accordance with the present modified example. FIG. 17 represents list screen 107 in which a lock setting is applied to notification information.

When list screen 107 is displayed on display surface 3 as shown in FIG. 8(b), the notification lock control processing can be started. The notification lock control processing can be executed in parallel with the first notification control processing and the second notification control processing.

Notification control module 31 can determine whether or not a setting operation, for example, a double-tap operation for performing the lock setting to display column 107a of notification information to which the lock setting is not applied is performed in list screen 107 (S401).

A user can perform a setting operation with respect to display column 107a of notification information which should not be deleted automatically. When notification control module 31 determines that the setting operation was performed (S401:YES), it can perform the lock setting (S402). For example, notification control module 31 can set a lock setting flag (not shown) provided in storage module 12 to be “1.” Further, as shown in FIG. 17, notification control module 31 can display a lock notification icon 111, which indicates that the lock setting is applied to the notification information, on display column 107a of notification information to which the setting operation was performed (S403).

When notification control module 31 determines that the setting operation was not performed (S401:NO), it can determine whether or not a release operation, for example, a double-tap operation for releasing the lock setting was performed with respect to display column 107a of notification information to which the lock setting is applied (S404). A user can perform a release operation to display column 107a of notification information which is allowed to be deleted automatically. When notification control module 31 determines that the release operation was performed (S404:YES), it performs unlocking (S405). For example, notification control module 31 can set the lock setting flag to be “0.” Further, notification control module 31 can delete lock notification icon 111 displayed on display column 107a of notification information to which the release operation was performed (S406).

When list screen 107 of notification information is deleted from display surface 3 (S407:YES), notification control module 31 can terminate the notification lock control processing.

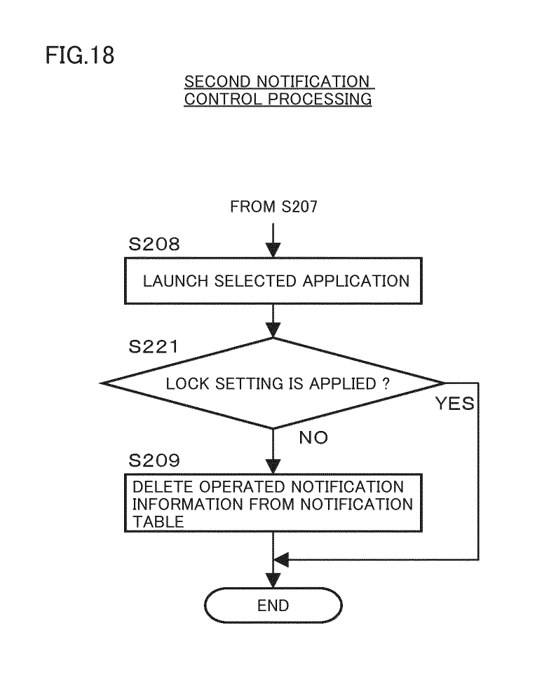

FIG. 18 is a flowchart representing a second notification control processing in accordance with the present modified example. In the second notification control processing of the present modified example, the processing of Step S221 is added to the second notification control processing shown in FIG. 6. It should be noted that, in FIG. 12, only a part of processing including added Step S221 is shown for convenience.

When notification control module 31 launches an application selected by a user from menu dialog 108 (S208), it can determine whether or not the lock setting is applied to the notification information subjected to the operation (S221). When notification control module 31 determines that the lock setting is not applied (S221:NO), it can delete the notification information subjected to the operation from notification table 12a (S209). On the other hand, when notification control module 31 determines that the lock setting is applied (S221:YES), it can terminate the second notification control processing without deleting the notification information subjected to the operation from notification table 12a.

In this manner, when the lock setting is applied to the notification information, the notification information is not deleted from notification table 12a even if an application is launched. Therefore, the notification information is not deleted from list screen 107.

Moreover, according to the present modified example, a user can retain the notification information which should not be deleted on list screen 107.

It should be noted that, when it is configured such that older notification information is deleted in order if the number of notification information displayed on list screen 107 reaches an upper limit number and thereafter new notification information is generated, it may be configured such that older notification information is not deleted from list screen 107 as long as the lock setting is applied to the notification information.

### Modified Example 3

In modified example 2 described above, notification information is not deleted from list screen 107 when the lock setting is applied to the notification information.

In mobile phone 1 in accordance with modified example 3, a notification information copying function is added to the notification function, by which a user can copy notification information displayed on list screen 107 and allow the copied notification information to be displayed on display surface 3 with a list screen which is other than list screen 107.

In order to achieve the notification information copying function, notification control module 31 can execute a copy control processing for copying notification information, and a copy information display control processing for displaying the copied notification information on display surface 3.

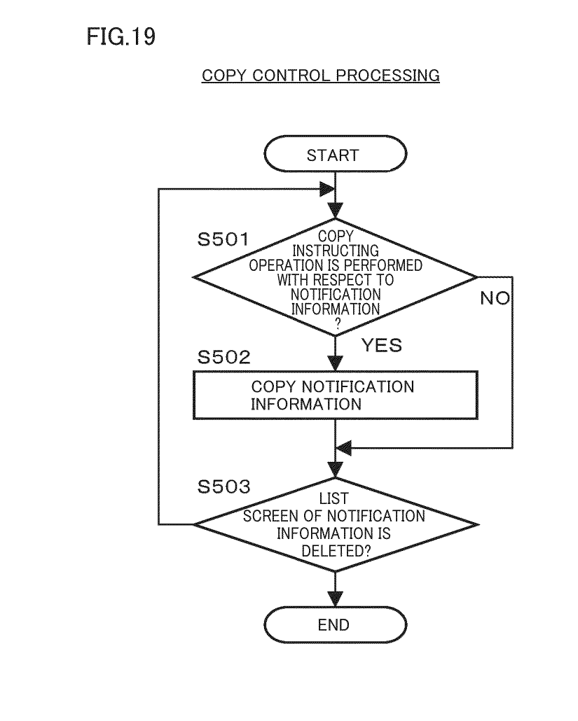

FIG. 19 is a flowchart representing the copy control processing in accordance with the present modified example. When list screen 107 is displayed on display surface 3 as shown in FIG. 8(b), the copy control processing is started. The copy control processing can be executed in parallel with the first notification control processing and the second notification control processing.

Notification control module 31 can determine whether or not an instructing operation, for example, a double-tap operation for instructing copying was performed with respect to any display column 107a of notification on list screen 107 (S501).

A user performs an instructing operation with respect to display column 107a of notification information which should be copied. When notification control module 31 determines that the instructing operation was performed (S501:YES), it can copy the notification information to which the instructing operation was performed, and store the copied notification information in storage module 12 (S502). When list screen 107 of the notification information is deleted from display surface 3 (S503:YES), notification control module 31 can terminate the copy control processing.

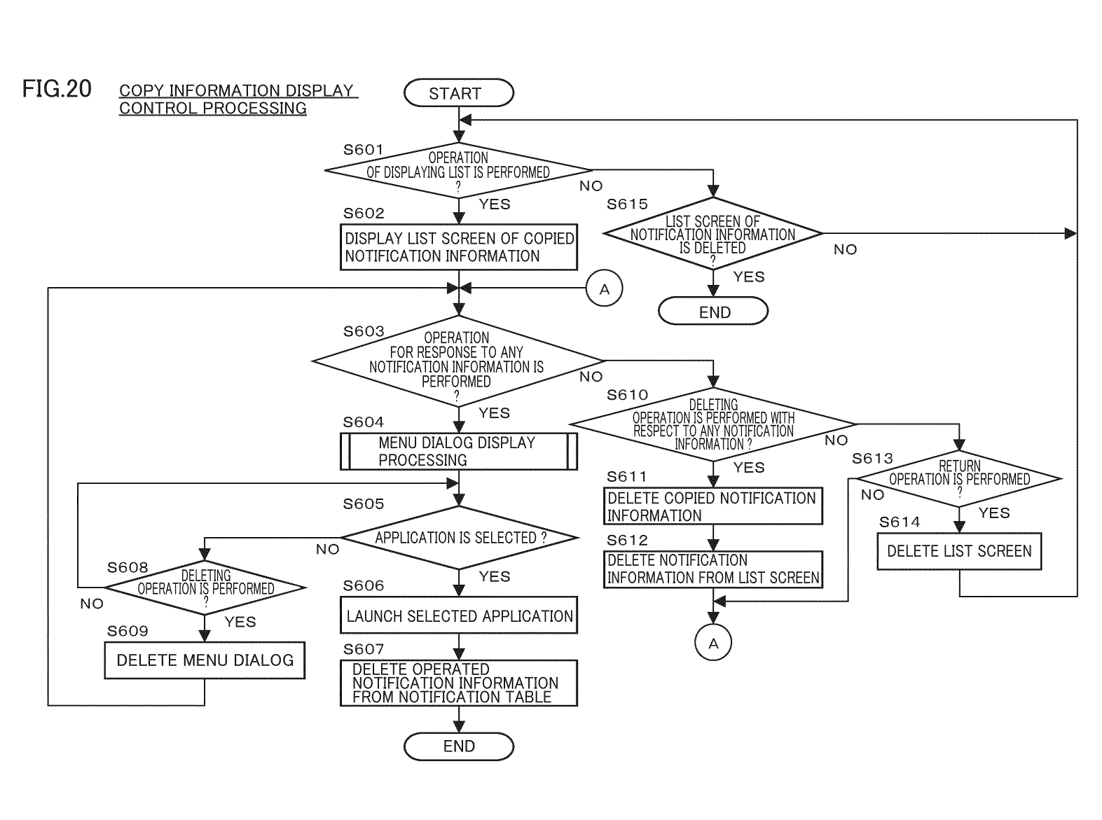

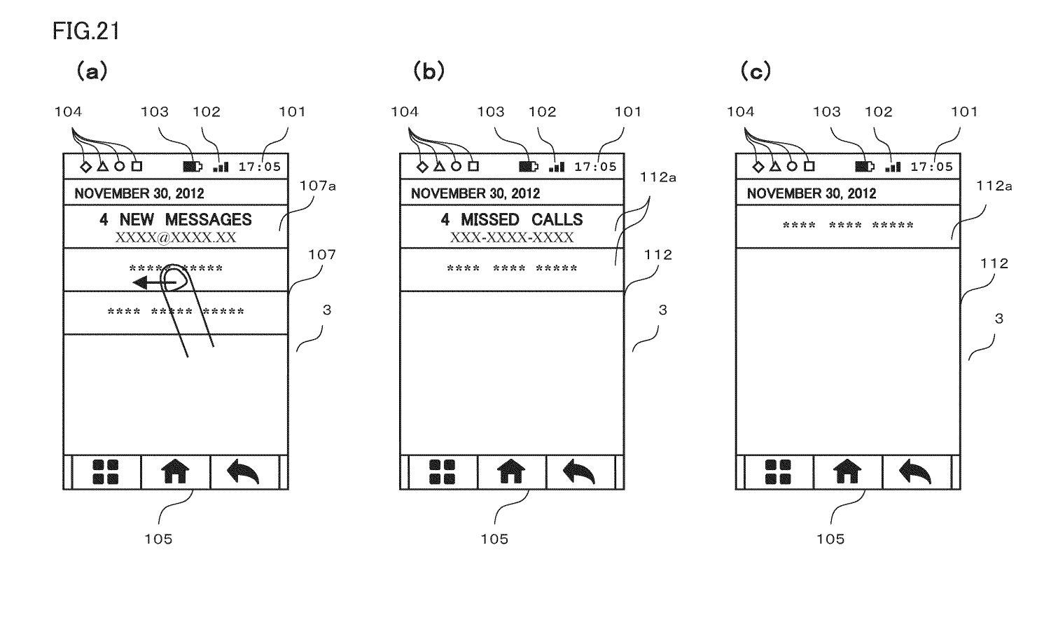

FIG. 20 is a flowchart representing the copy information display control processing in accordance with the present modified example. FIG. 21 represents one example of a screen transition which is provided when the copy information display control processing is executed.

When list screen 107 is displayed on display surface 3 as shown in FIG. 8(b), the copy information display control processing is started. The copy information display control processing is executed in parallel with the copy control processing.

Notification control module 31 can determine whether or not an operation for displaying copied notification information in a list on display surface 3 was performed in a state where list screen 107 is displayed on display surface 3 (S601). The operation for a displaying a list, for example, a leftward flick operation with respect to list screen 107 as shown in FIG. 21(a).

When notification control module 31 determines that the operation for displaying a list was performed (S601:YES), it can read the copied notification information from storage module 12 and display a list screen 112 of the read notification information on display surface 3 (window region RW). As shown in FIG. 21(b), the copied notification information is displayed in each display column 112a constituting list screen 112.

Notification control module 31 can determine whether or not an operation for responding to the notification information, for example, a single-tap operation was performed with respect to any display column 112a of notification information (S603). When notification control module 31 determines that the operation for a response was performed (S603:YES), it can display menu dialog 108 on display surface 3, similarly to the processing of Steps S204 and S207 to S211 of the second notification control processing shown in FIG. 6, and execute a series of processing (Steps S604 to S609) for launching an application selected from menu dialog 108.

Further, when notification control module 31 determines that the operation for a response was not performed (S603:NO), it can determine whether or not a deleting operation, in other words, a double-tap operation was performed with respect to any display column 112a of notification information (S610).

When notification control module 31 determines that the deleting operation was performed (S610:YES), it can delete the notification information to which the deleting operation was performed, in other words, the copied notification information from storage module 12. Further, notification control module 31 can delete the notification information to which the deleting operation was performed from list screen 112 as shown in FIG. 21(c) (S612).

When a return operation, for example, a single-tap operation with respect to back key 105c was performed in a state where list screen 112 is displayed (S613:YES), notification control module 31 can delete list screen 112. List screen 107 can be displayed again on display surface 3.

When list screen 107 of notification information is deleted from display surface 3 (S615:YES), notification control module 31 can terminate the copy information display control processing.

As described above, according to the present modified example, a user can copy notification information. Even when an application is launched, and the notification information is deleted from list screen 107, a user can confirm the copied notification information by displaying it on new list screen 112. A user can launch an application associated with copied notification information by an operation on list screen 112.

### <Other>

As described above, an embodiment and modified examples were illustrated. However, the present disclosure is not limited by the embodiment and the like described above, and various modifications can be made also for the embodiment.

For example, in the embodiment described above, as a selection image for selecting an application to be launched from a plurality of applications associated with notification information, menu dialog 108 having each menu 108a arranged in an upward/downward direction is displayed on display surface 3. However, the selection image may employ any display form as long as an application to be launched can be selected. For example, a window in which icons corresponding to each application to be selected is arranged in a matrix form may be displayed on display surface 3.

Further, in the above-described embodiment, notification information is displayed by means of list screen 107 in which display columns 107a are arranged in an upward/downward direction of display surface 3. However, notification information may be formed on display surface 3 in any form as long as a list of notification information is displayed.

Further, in the above-described embodiment, one or a plurality of applications are associated in accordance with a kind of notification information displayed by means of list screen 107. However, a plurality of applications may be associated with all the notification information.

Further, in modified example 1 described above, when the notification information is the missed call information, as a change condition, the determination is made on whether or not the time when mobile 1 is present is within the predetermined time. However, when there is only one missed call information, the determination may be made on whether or not the time of the caller within the time is within the predetermined time. Similarly, when the notification information is the new message information, as a change condition, the determination on use frequencies of each message (e-mail, SMS, voice mail) in mobile phone 1 was made. However, when there is only one new message information, the determination may be made on a frequency of each message transmitted from a sender side.

Further, missed call information and/or new message information may be associated with a plurality of telephone applications (a telephone application using a telephone network, a telephone application using a data communication network, and the like). In this case, a use frequency of each telephone application before the operation for a response may be set as a change condition, a priority of the telephone application may be changed in accordance with a use frequency. For example, a priority is in a higher rank as a telephone application has a higher use frequency. Alternatively, a cumulative telephone call time by each telephone application before an operation for a response is performed may be set as a change condition, and a priority of a telephone application may be changed in accordance with the cumulative telephone call time. For example, a priority is in a higher rank as a telephone application having a longer cumulative telephone call time.

The present disclosure is not limited to a mobile phone and is also applicable to various mobile terminal apparatuses such as a PDA (Personal Digital Assistant), a tablet PC, an electronic book terminal, and the like.

Although the present invention has been described and illustrated in detail, it is clearly understood that the same is by way of illustration and example only and is not to be taken by way of limitation, the scope of the present invention being interpreted by the terms of the appended claims.

1. A mobile terminal apparatus, comprising:
a display module configured to comprise a display surface;
an operation receiving module configured to receive an operation by a user;
a storage module configured to store correspondence information associating notification information with a plurality of applications for a response to the notification information; and
a notification control module configured to display the notification information on the display surface, display on the display surface a selection image for selecting an application to be launched from among a plurality of applications associated with the notification information when an operation to designate the notification information is received by the operation receiving module, and launch the selected application when an operation to select the application is received by the operation receiving module,
the notification control module being configured to change an arrangement of a plurality of applications associated with the notification information in the selection image based on priorities.

2. The mobile terminal apparatus according to claim 1, wherein
the selection image comprises a list in which information for selecting an application as a selection object is arranged, and
the notification control module is configured to change an arrangement of information for selecting the application in the list based on priorities.

3. The mobile terminal apparatus according to claim 1, wherein
the notification information comprises missed call information related to a missed call, and
an application associated with the missed call information comprises a telephone application for making a telephone call and a message application for sending a message, and
the notification control module is configured to set a priority of the telephone application to be higher than a priority of the message application.

4. The mobile terminal apparatus according to claim 1, wherein
the notification information comprises new message information related to a new arrival of a message, and
an application associated with the new message information comprises a message application for sending a message and a telephone application for making a telephone call, and
the notification control module is configured to set a priority of the message application to be higher than a priority of the telephone application.

5. The mobile terminal apparatus according to claim 1, wherein
the notification information comprises missed call information related to a missed call, and
an application associated with the missed call information comprises a telephone application for making a telephone call and a message application for sending a message, and
the notification control module is configured to change priorities of the telephone application and the message application based on a time on which the missed call information is designated.

6. The mobile terminal apparatus according to claim 1, wherein
the notification information comprises at least one of missed call information related to a missed call and new message information related to a new arrival of a message, and
an application associated with the notification information comprises a first message application for sending a message and a second message application for sending a message which is of a kind different from that of the first message application, and
the notification control module is configured to change priorities of the first message application and the second message application in accordance with use frequencies of the first message application and the second message application in the mobile terminal apparatus before the notification information is designated.

7. The mobile terminal apparatus according to claim 1, wherein
the notification information comprises at least one of missed call information related to a missed call and new message information related to a new arrival of a message, and
an application associated with the notification information comprises a first telephone application and a second telephone application which is of a kind different from that of the first telephone application, and
the notification control module is configured to change priorities of the first telephone application and the second telephone application in accordance with use frequencies or cumulative phone call time of the first telephone application and the second telephone application in the mobile terminal apparatus before the notification information is designated.

8. A control method for a mobile terminal apparatus comprising a display module configured to comprise a display surface, and an operation receiving module configured to receive an operation by a user, the control method comprising:
the first step of displaying notification information on the display surface;
the second step of displaying on the display surface a selection image for selecting an application to be launched from among a plurality of applications associated with the notification information when an operation to designate the notification information is received by the operation receiving module; and
the third step of launching the selected application when an operation to select the application is received by the operation receiving module,
in the second step, an arrangement of a plurality of applications associated with the notification information in the selection image being changed in accordance with priorities.
